(19) United States
(12) Patent Application Publication
(10) Pub. No.: US 2018/0322987 A1
(43) Pub. Date: Nov. 8, 2018

(54) BULK WIRE BEND RADIUS MANAGER

(71) Applicant: International Business Machines Corporation, Armonk, NY (US)

(72) Inventors: Paul W. SCHAEFER, Rochester, MN (US); Sandra J. SHIRK/HEATH, Rochester, MN (US)

(21) Appl. No.: 15/589,048

(22) Filed: May 8, 2017

(51) Int. Cl. H01B 13/14; H01B 13/00; H01B 7/00; H01B 7/04

(52) U.S. Cl. CPC H01B 13/145; H01B 7/04; H01B 7/0009; H01B 13/0036

(57) ABSTRACT

A particular method includes using a helical forming tool to make helical grooves on an insulating jacket of a conductive length, such as a wire. A gear may rotate a forming mechanism, such as a protrusion, around the insulating jacket to form the helical grooves. The helical grooves are formed to limit bending of the insulated wire.

### I. FIELD OF THE DISCLOSURE

The present disclosure relates generally to bulk wire cable and insulation, as well as a method of manufacturing the same.

### II. BACKGROUND

Bulk wire cable is conventionally covered in insulation for protection and performance considerations. Care must be taken to assure that the bulk wire in the cable does not become bent into too tight of a bend radius. Bending the bulk wire too much can crush the dielectric insulation or harm the wiring. Crushed or otherwise deformed dielectric insulation can result in reduced electrical performance, shorts between conductors, overstress on the wire termination, and cable failure. Compounding this problem, some of this damage can be difficult to detect and identify.

### III. SUMMARY OF THE DISCLOSURE

According to a particular embodiment, a method includes coating a conductive length with insulating material and forming a plurality of grooves in the insulating material. The grooves may be formed in a single step as the coated conductive wire is extruded.

The method may include forming a plurality of helical grooves. A forming mechanism may be rotated around an outer diameter of the insulating material. A gear may be used to rotate the forming mechanism around the insulating material. The conductive length may be a single wire. The conductive length of another embodiment may include a bundle of wires. The insulating material may include a dielectric material. The method may include determining a desired bend radius. The determination may be based on an outside diameter of the insulating material. A motor may be used to rotate a forming mechanism used to form the plurality of grooves. A ball bearing may be used to support a rotation of a forming mechanism used to form the plurality of grooves. The conductive length may be automatically advanced through a forming mechanism configured to form the plurality of grooves.

According to another particular embodiment, an apparatus may include an extrusion mechanism to apply an insulating jacket to a conductive length. A groove forming mechanism may be used to form a plurality of grooves on a surface of the insulating jacket.

The apparatus may include a groove forming mechanism. The groove forming mechanism may be configured to rotate around an outer diameter of the insulating jacket. The plurality of grooves may be helical. The apparatus may include a plurality of gears.

According to another particular embodiment, an apparatus includes a conductive length and an insulating jacket covering at least a portion of the conductive length. The insulating jacket may include a plurality of helical grooves formed on a surface of the insulating jacket.

The plurality of helical grooves may restrict a bend radius of the conductive length. A number of the plurality of helical grooves may be determined as a product of an outer diameter of the insulating material.

One advantage of the present disclosure is a limiting of the bend radius of a bulk wire by the helical striations. The helical striations, or grooves, may be formed throughout the length of a cable during a single step of the extrusion process. The grooves may not take up additional room or necessitate special tools or other equipment to install the cable. The helical striations may reduce instances when the operator may accidentally bend the cable during installation.

### IV. BRIEF DESCRIPTION OF THE DRAWINGS

FIG. 1 shows an embodiment of a tooling system for extruding a bulk wire cable jacket in such a manner as to form helical striations in the jacket;

FIG. 2 shows an embodiment of a close up view of a helical forming tool system similar to that shown in FIG. 1;

FIG. 3 shows a frontal view of a helical forming tool system that includes a first gear and a second gear;

FIG. 4 shows a side view of a bulk wire jacket with helical striations as formed as part of an extruding operation; and

FIG. 5 illustrates a side view of a bent extruded bulk wire jacket having helical grooves.

### V. DETAILED DESCRIPTION

An embodiment of a system and method controls the bend radius of a bulk wire by extruding a bulk wire jacket with helical striations. The helical striations may limit bending. The system may control the cable bend radius over the entire length of the cable (e.g., not just a portion of the cable). The helical striations may also not take up additional room in the side of the rack. Furthermore, an operator may not need special tools or other equipment to install the cable, and the helical striations may reduce instances when the operator accidentally bends the cable during installation.

The striations may be customized to an individual cable and according to desired bend radius specifications. The bend limiting feature may be accomplished during a cable jacketing process as a single step. Performing the jacketing process as a single step (i.e., scoring as part of the extrusion process) may result in a lower cost process and smaller cable bulk wire outside diameter. The system may use tooling configured to perform the jacketing in a single step. An embodiment of a system jackets a bare cable.

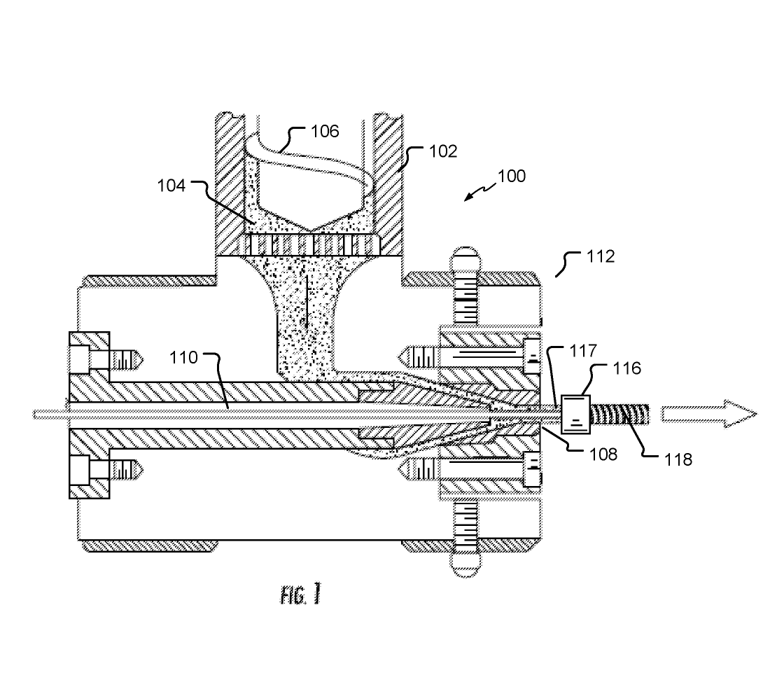

FIG. 1 shows an embodiment of a tooling system 100 for extruding a bulk wire cable jacket. The system 100 may include a barrel 102 into which insulation, or jacket material 104, is inserted. According to a particular embodiment, the jacket material 104 may be heated, or melted, above room temperature to a desired viscosity. An example of the jacket material 104 may include plastic, polymer (e.g., polytetraflouoroethylene and polyvinyl chloride), and dielectric material, among others. A screw 106 may be used to move the melted jacket material 104 into an insulation guiding mechanism 108 that coats a wire 110.

An example of a wire 110 may include an individual conductor (e.g. a bare copper wire), bundled cable, fiber optic cable, and coaxial cable, among other conductors. The wire 110 may be coated by the melted jacket material 104 as the wire 110 is advanced (left to right, as designed by the arrow shown in FIG. 1) through a forming die 112. The insulated wire 117, i.e., now covered in the soft jacket material 104, may be advanced into a helical forming tool 116. The helical forming tool 116 may rotate as the insulated wire 117 is extruded.

According to a particular embodiment, the helical forming tool 116 cuts, shapes, or otherwise forms helical grooves in the soft insulated jacket 117 covering the wire 110. The grooved, insulated jacket 118 may then be cooled in water (not shown).

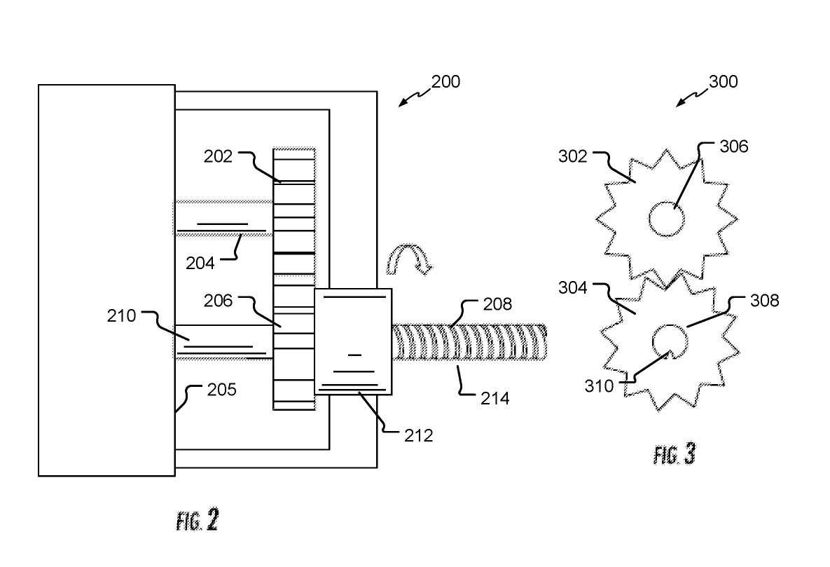

FIG. 2 shows an embodiment of a helical forming tool system 200. The helical forming tool system 200 may be similar to the helical forming tool 116 of FIG. 1. The system 200 includes a first gear 202 that is actuated by a gear shaft 204. For example, a small motor in block 205 may rotate the gear shaft 204. The first gear 202 may couple to and rotate a second gear 206. The second gear 206 may include a forming protrusion (not shown) that forms helical grooves 208 in a jacket of insulated wire 210. The second gear 206 may be engaged by the first gear 202 and may spin while seated on a ball bearing 212. The ball bearing 212 may include an aperture aligned with the aperture in the second gear 206 to accommodate the travel of the insulated wire 210. The insulated wire 210 may be similar to the insulated wire 117 of FIG. 1. According to a particular embodiment, the insulated wire 210 may be advanced through the second gear 206 (i.e., in a left to right direction, as shown in FIG. 2) to form an insulated cable 214 with helical grooves 208. The grooved, insulated cable may be similar to the grooved, insulated jacket 118 of FIG. 1.

FIG. 3 shows a front view of a helical forming tool system 300 that includes a first gear 302 and a second gear 304. The first and second gears 302, 304 may be similar to a front view of the first and second gears 202, 206 of FIG. 2. A rotating shaft 306 rotates the first gear 302. An insulated extruded conductor 308 is shown positioned within the second gear 304. A forming protrusion 310 is included within the second gear 304. The forming protrusion 310 may be pointed or blunt or nearly any shape sufficient to form a groove in the jacket material.

The second gear 304 and the protrusion 310 may rotate as the jacket of the conductor 308 is extruded to form helical grooves on the jacket. While the jacket material of a particular embodiment is soft, the jacket material of another material may be cooled and rigid. Additionally, while helical grooves are shown in FIGS. 1 and 2, the grooves of another embodiment may be circular or another shape that restricts bending of a jacketed cable.

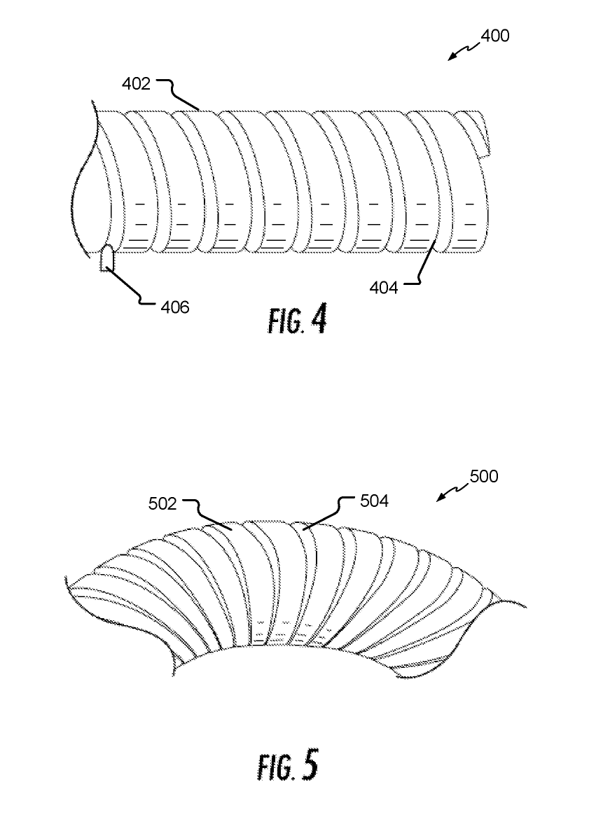

FIG. 4 shows a side view of a bulk wire jacket 402 with helical striations 404 as formed as part of an extruding operation. A forming protrusion 406 is included in the illustration to demonstrate how the striations 404 are formed as the jacket 402 moves from left to right with respect to the rotating protrusion. The forming protrusion may be similar to the forming protrusion 310 of FIG. 3, and the bulk wire jacket 402 may be similar to the insulated extruded conductor 214 of FIG. 2.

The thickness of the insulated jacket at the bottom of the formed helix may be sufficiently thick to insulate the wire according to meet industry code or customer specifications. A bend radius may be calculated as a product of the outside diameter of the jacket. The inside radius of the jacket becomes smaller and the outside radius of the jacket becomes larger as the insulated wire is bent. According to a particular embodiment, the formed jacket material may include four to seven grooves per inch.

FIG. 5 illustrates a side view of a bent extruded bulk wire jacket 502 having helical grooves 504. In the particular embodiment, the helical grooves 504 compress together as the bulk wire jacket 502 is bent to limit a bend diameter.

Aspects of the present disclosure are described herein with reference to illustrations and/or block diagrams of methods, and apparatus (systems according to embodiments of the disclosure). It will be understood that illustrations and/or block diagrams, and combinations illustrations and/or block diagrams, can be implemented by computer-readable program instructions (e.g., software for programming an extruder machine to make grooves having particular spacing, shape, and distance).

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to explain the principles of the embodiments, the practical application or technical improvement over technologies found in the marketplace, or to enable others of ordinary skill in the art to understand the embodiments disclosed herein.

Those skilled in the art can make numerous uses and modifications of and departures from the apparatus and techniques disclosed herein without departing from the described concepts. For example, components or features illustrated or described in the present disclosure are not limited to the illustrated or described locations, settings, or contexts. Examples of apparatuses in accordance with the present disclosure can include all, fewer, or different components than those described with reference to one or more of the preceding figures. The present disclosure is therefore not to be limited to specific implementations described herein, but rather is to be accorded the broadest scope possible consistent with the appended claims, and equivalents thereof.

1. A method comprising:
coating a conductive length with insulating material; and
forming a plurality of grooves in the insulating material as the coated conductive wire is extruded.

2. The method of claim 1, wherein forming the plurality of grooves further includes forming a plurality of helical grooves.

3. The method of claim 1, wherein forming the plurality of grooves further includes rotating a forming mechanism around an outer diameter of the insulating material.

4. The method of claim 3, further comprising using at least one gear to rotate the forming mechanism.

5. The method of claim 1, wherein the conductive length includes a single wire.

6. The method of claim 1, wherein the conductive length includes a bundle of wires.

7. The method of claim 1, wherein the insulating material includes a dielectric material.

8. The method of claim 1, further comprising determining a desired bend radius.

9. The method of claim 1, further comprising determining a desired bend radius based on an outside diameter of the insulating material.

10. The method of claim 1, further comprising using a motor to rotate a forming mechanism used to form the plurality of grooves.

11. The method of claim 1, further comprising using a ball bearing to support a rotation of a forming mechanism used to form the plurality of grooves.

12. The method of claim 1, further comprising advancing the conductive length through a forming mechanism configured to form the plurality of grooves.

13. An apparatus comprising:
an extrusion mechanism to apply an insulating jacket to a conductive length; and
a groove forming mechanism to form a plurality of grooves on a surface of the insulating jacket.

14. The apparatus of claim 13, further comprising a groove forming mechanism.

15. The apparatus of claim 14, wherein the groove forming mechanism is configured to rotate around an outer diameter of the insulating jacket.

16. The apparatus of claim 13, wherein the plurality of grooves are helical.

17. The apparatus of claim 13, further comprising a plurality of gears.

18. An apparatus comprising:
a conductive length; and
an insulating jacket covering at least a portion of the conductive length, wherein the insulating jacket includes a plurality of helical grooves formed on a surface of the insulating jacket.

19. The apparatus of claim 18, wherein the plurality of helical grooves restrict a bend radius of the conductive length.

20. The apparatus of claim 18, wherein a number of the plurality of helical grooves is determined as a product of an outer diameter of the insulating material.
